(19) United States
(12) Patent Application Publication
(10) Pub. No.: US 2003/0228554 A1
(43) Pub. Date: Dec. 11, 2003

(54) Dental tool

(76) Inventor: Milton F. Brown JR., Virginia Beach, VA (US)

Correspondence Address: Bradley D. Goldizen, Suite 102, 505 S. Independence Blvd., Virginia Beach, VA, 23452, US

(21) Appl. No.: 10/163,936

(22) Filed: Jun. 6, 2002

(51) Int. Cl. A61C 3/06; A61C 15/00

(52) U.S. Cl. 433/142; 132/321

(57) ABSTRACT

The invention discloses a thin strip of plastic or other suitable material for dental hygiene. The material may be flat, curved, or have a portion of a partially cut or flattened tube. The strip includes a shaped tine on one end and a rimmed, folded or tubular grip on the other end. The material may include holes, slits or ribs and some porosity and a sac or pellet of absorbent material placed within or on the strip containing small amounts of antiseptics, cleansers or abrasive particles, pastes or other soluble or insoluble materials which are released into the folds, holes or slits along the length of the strip. The strips are capable of being a part of or joined at or near the grip with a similar strip of different configuration or, if tubular, a section of extendible, bendable concentric rings have an extension for holding or forming a similar strip of different configuration or providing means for inserting or attaching a bristle brush or other dental device.

There are no related applications.

This patent application did not receive any federal research and development funding.

### BACKGROUND OF THE INVENTION

Previously, dental devices for cleaning small openings and spaces between the teeth have been inflexible wooden, metal or plastic picks, and threads, flosses and brushes having fine bristles. Problems arise with the use of these dental cleaning devices. For example, inflexible picks tend to loosen filings, crowns and bridges when used forcibly to remove debris between teeth. Further, these picks are not equipped with folds, slots, holes or notches for retaining pastes, fresheners, or antiseptics to help cleanse the teeth.

If a floss-holder is not used when employing threads or flosses to remove debris from between the teeth, the user must hold the thread or floss with both hands while pressing either between the teeth. While a floss holder may be used with one hand, it must be pressed in and pulled out at the tip of the teeth. Great care must be exercised when the user employs fine or small diameter thread or floss to clean teeth, since the use of these cleaning tools increases ones chances of catching them on protrusions extending from a filling, crown or bridge. Thus, the use of floss holders and small diameter floss or thread may loosen or destroy dental improvements requiring expensive dental repair.

### BRIEF SUMMARY OF THE INVENTION

This invention relates to a thin, small, semi-flexible and easily insertable dental cleansing strip. The invention includes an embodiment of the strip that is folded along its length. Another embodiment of the invention includes a curved or sickle-shaped portion. A further embodiment includes a strip that is tapered along its length from a gripping or holding portion to a tine at the opposite end.

The strips include a gripping or holding portion. They typically comprise plastic. The strips may be joined with a second strip having a different configuration. They may be connected near the gripping portion. Or, they include a section of a tube partly cut away or flattened near each end. The tube may have concentric extendible rings near the grip joining a similar tube strip opposite the grip. They may also include a receptacle for inserting an end of a different strip, bristle brush or other dental cleansing device. The strips may include slots, holes, notches or serrations along its length to aid in the removal of food debris and release of selected cleansing materials between the teeth, beneath bridges and other small openings and spaces.

It is an object of the invention to provide a reliable, safe and effective device for cleaning food debris from teeth. The device is typically inserted at the gum level between the teeth and is slid across the gums to remove deposits that pose the greatest threat of becoming food sources for bacterial infections and decay. The device also cleans debris from between the teeth from the gum level to a point near or at the top or tip of the tooth. The strips are readily insertable and removable by the use of one hand.

A further object of the invention is to incorporate the strips with holes, notches, slots or ribs, either vertical or slanted formation along the length of the strip. The holes, slots and ribs impose small upward and lateral pressures and pressure releases at intervals. By moving the strips at different angles or to and fro, these holes, slots and ribs assist in removal of particles, deposits, debris and tartars.

Another object of the invention is to provide a means for introducing and applying healing, cleansing and refreshing pastes, ointments and fluids on or between the teeth and gums. Usually these pastes, ointments and fluids are released from folds, slots, holes and pockets along the strip.

A further purpose of the invention is to provide a selection of sizes in one device by providing a second strip having a different configuration that is joined near the grip or is an integral part of the first strip.

Yet another object of the invention is to provide a trip into or on which a small reservoir, sac, sponge or capsule of absorbent material may be fixed. The absorbent material may retain cleansing, refreshing, healing or abrasive materials for the cleaning and protection of gums, teeth and mouth. The materials may be released by applying pressure on the grip of the strip.

Another purpose of the invention is to disclose the use of a tubular strip halved, quartered or notched on one side and having a tubular center with concentric extendible rings enabling the user to bend the strip to a desired angle to facilitate insertion of the strip between the teeth. The extendible rings typically allow a user to position the pick end of the tubular strip at right angles to the grip. Thus, the extendible rings facilitate insertion of the pick end of the strip between teeth that are more difficult to reach.

Another object of the invention is to provide a strip with a brush having fine bristles either permanently or detachably fixed or attached on an end opposite the pick end. Other dental cleaning or hygiene devices may be permanently or detachably fixed in an end of the strip to aid in removal of fine particles and deposits.

Further objects, features and advantages of the invention will become apparent from a consideration of the following description and the included claims when taken in connection with the previous discussion and the accompanying drawings.

### BRIEF DESCRIPTION OF THE DRAWINGS

FIG. 1 is a plan view of a first embodiment of the invention showing it from the side.

FIG. 2 is a plan view of a second embodiment of the invention taken from the side.

FIG. 3 is a plan view of FIG. 2 taken from above.

FIG. 4 is a plan view of a third embodiment taken from the side.

FIG. 5 is a view from below FIG. 4.

FIG. 6 is a side view of a fourth embodiment of the invention.

FIG. 7 is a view of FIG. 6 from above.

FIG. 8 is a side view of a fifth embodiment of the invention.

FIG. 9 is a side view of a sixth embodiment of the invention.

### DETAILED DESCRIPTION OF THE INVENTION

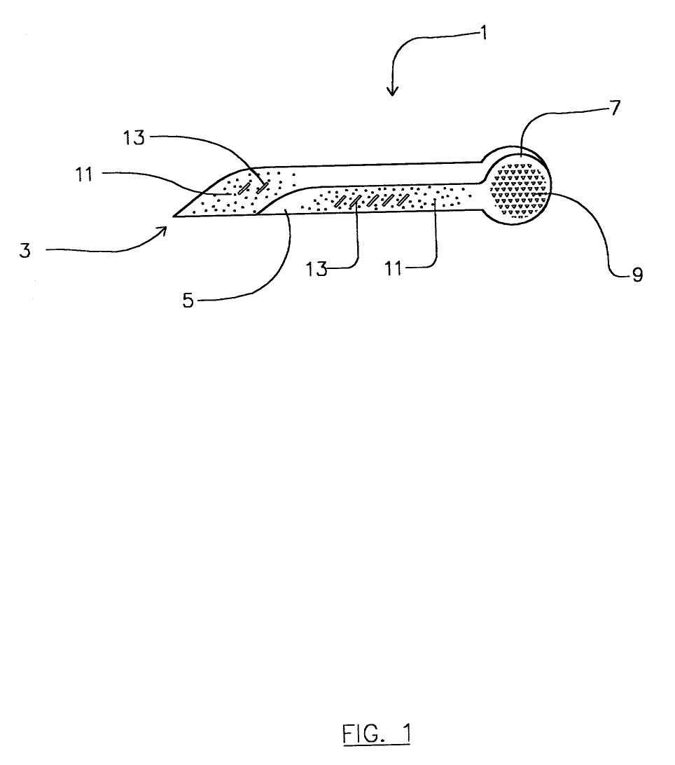

FIG. 1 is a thin strip 1 that is flat or curved across its width and straight along its length. The strip 1 includes a fold portion 5 that is folded along the bottom length of the strip 1 and over a grip 7 as shown. Spaced holes 11 or slots 13 are included along the strip 1 and in the fold 5. A mesh 9 may also be included on the grip 7.

In FIG. 1, the flexible strip 1 comprises plastic or other suitable material. A tine 3 is located at an end of the strip 1 opposite the grip 7. The fold 5 helps to strengthen the strip 1 and may serve as a groove. The mesh 9 may be laminated to one or both sides of the grip 7.

In the preferred embodiment, the strip 1 has a thickness of between 0.003 and 0.006 inches and may taper in width from a point at tine 3 to grip 7. The width of the grip 7 may be between 0.225 to 0.250 inches. The tapered width allows the strip 1 to reach from the gum-line of the user at fold 5 to the tip of the tooth at the strip's widest point near the grip 7. Thus, the strip 1 is easily insertable between teeth and will ordinarily clean a tooth surface from the gum to the tip with by passing the strip between the teeth.

The fold 5 may be either tightly compressed or lightly compressed. When tightly compressed, the fold 5 provides maximum stiffness to the strip 1. When lightly compressed, the fold 5 provides a groove for retaining cleansers and gathering deposits from the gum-line. Strip 1 may also be inverted and inserted between teeth at their tips. A second fold may be provided on the topside of the strip 1. The second fold is typically thicker than the fold on the bottom. The second fold adds strength to the strip 1 and greater resistance to bending.

Strip 1 may have small holes 11 and thin slots 13 cut or formed at selected points along its length and in the fold 5. The preferred plastic for providing strength and stiffness in such a very thin strip 1 is one made by the metallocene catalysts and processes. The mesh 9 provides a means for cleansing surfaces of frontal teeth.

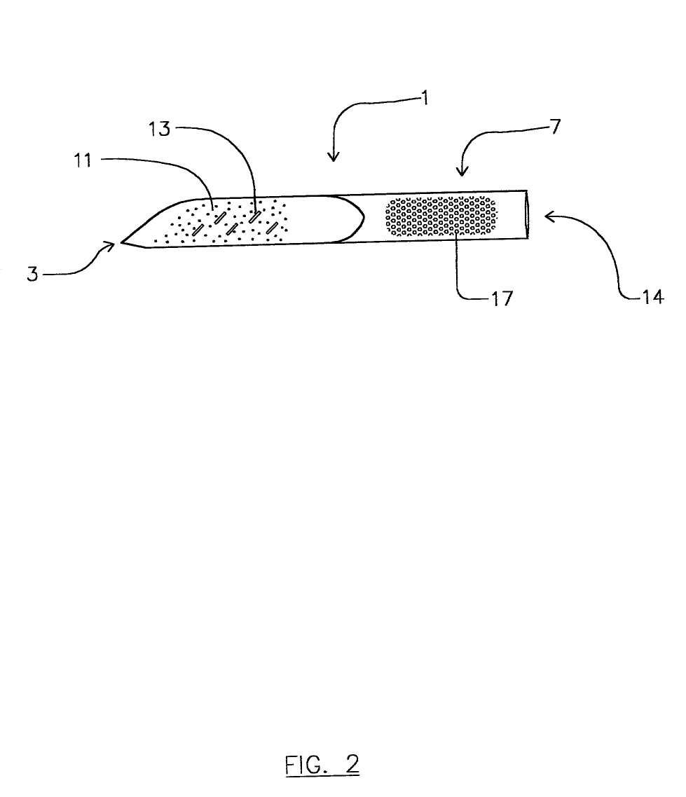

FIG. 2 shows a tubular strip 1. The strip 1 includes a cut portion that is half or less than half of the circumference of tube 14. The full tube section serves as the grip 7. A sac 17 or plug of absorbent material may be fixed in the tubular grip portion 7.

The strip 1 runs along its length from tine 3 to a point near the uncut portion of the full tube 14. The tine 3 also tapers in width as shown. The sac 17 or plug of absorbent material holds fluids or pastes such as dental cleansers, fresheners or other substances which are released by exerting pressure onto grip 7. The strip 1 shown in FIG. 2 may also be equipped with fine holes 11 or thin slots 13.

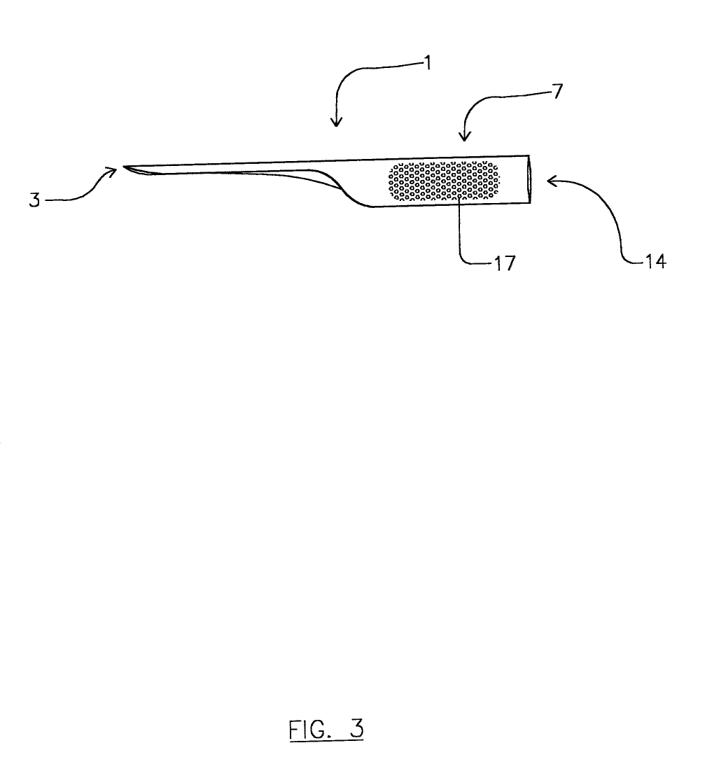

FIG. 3 shows an overhead view of FIG. 2. This view clearly shows the slight lateral taper of the strip 1 to a point near the tube 14. The lateral taper adds rigidity to the strip 1. Without the lateral taper, the strip tends to bend easily when inserted between teeth of the user. Near the tube 14, the strip 1 tapers sharply to the full diameter of tube 14.

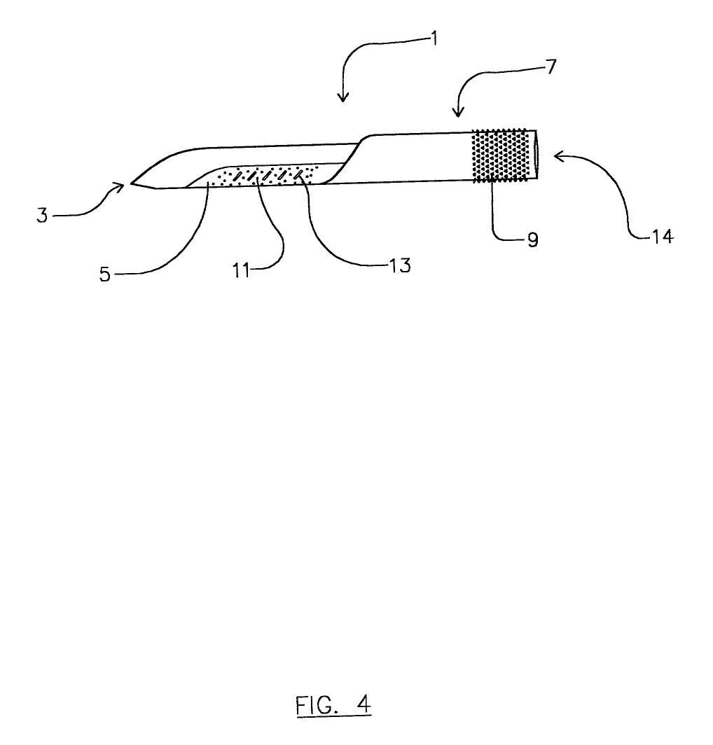

FIG. 4 is a plan view of a third embodiment of the invention. In FIG. 4, a tubular type strip 1 is halved along its length. A bottom portion is folded up to a point at which an uncut portion of the tube 14 serves as a grip 7. Mesh 9 may be fixed around the grip 7.

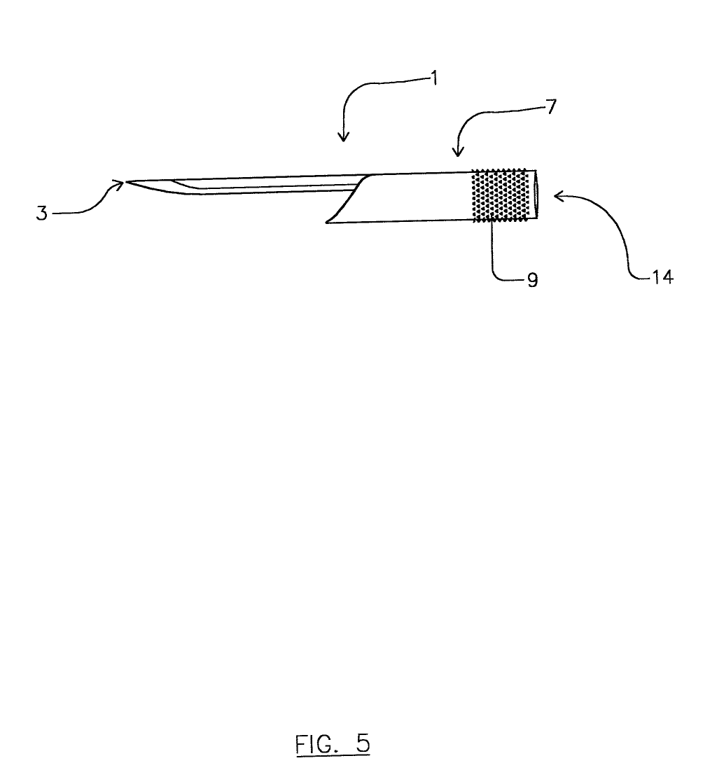

FIG. 5 is a top view of FIG. 4 showing the thickness added by the fold 5 along the bottom edge of the thin strip 1. Without this added thickness, the strip 1 tends to bend when inserted between the teeth of the user.

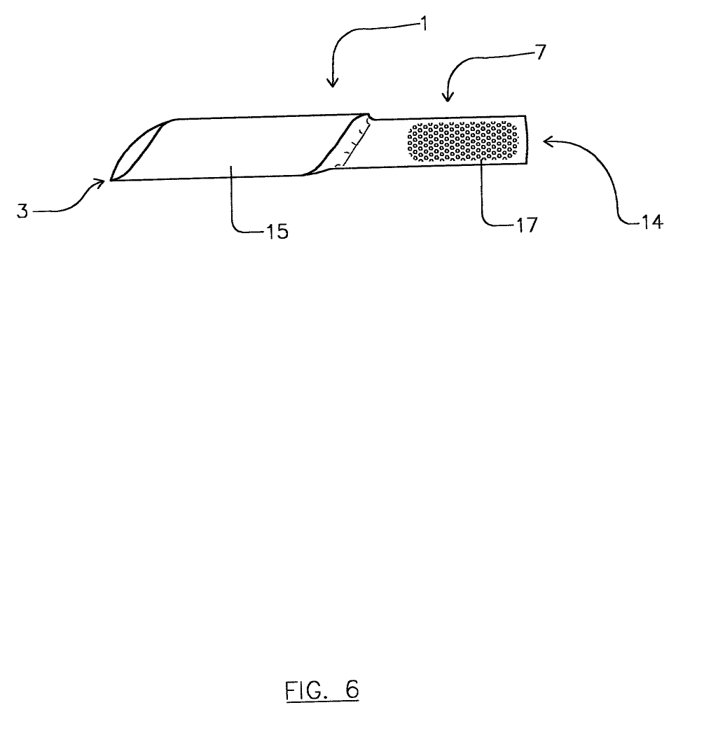

FIG. 6 is a side view of a tubular type strip 1 in which a portion of the entire tube has been flattened from the tine 3 to a point near the grip 7. A sac or plug 17 containing absorbent material is included in the grip 7. The flattened portion 15 is typically cut back to obtain a tine 3 having a slant to permit easy insertion of the strip 1 at the gum level.

The flattened portion 15 is continued along the length of the strip 1 to a point near the grip 7 at which point the flattened portion 15 is also slanted back from the bottom to the top to avoid or reduce bending of the strip 1 by doubling the bend line while maintaining the thinner portion on top and creating an enlarging bottom portion at the gum line. This design provides added rigidity to the tine 3.

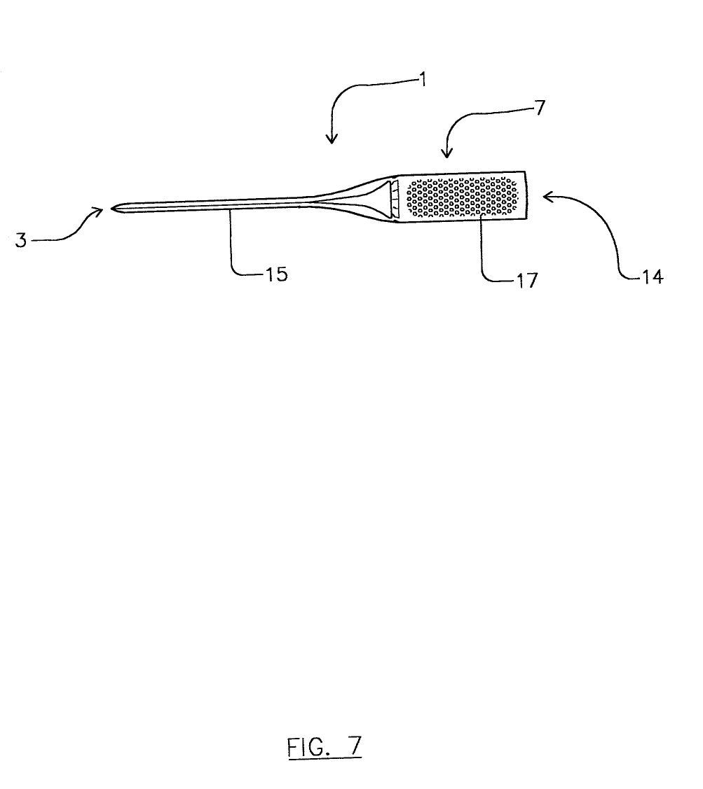

FIG. 7 is a top view of FIG. 6 showing the rigid design. The design is much stronger than one having a straight compression line perpendicular to a horizontal axis taken along the length of the strip 1. Such straight compression line creates a vertical hinge that bends easily. By making a compression line at an angle less than ninety degrees to the horizontal axis, strength may be added to the strip 1. However, the strength of the strip is maximized when the compression line is made at a forty-five degree angle to the horizontal axis. It is preferred that the compression line be made such that it intersects a tip of the strip.

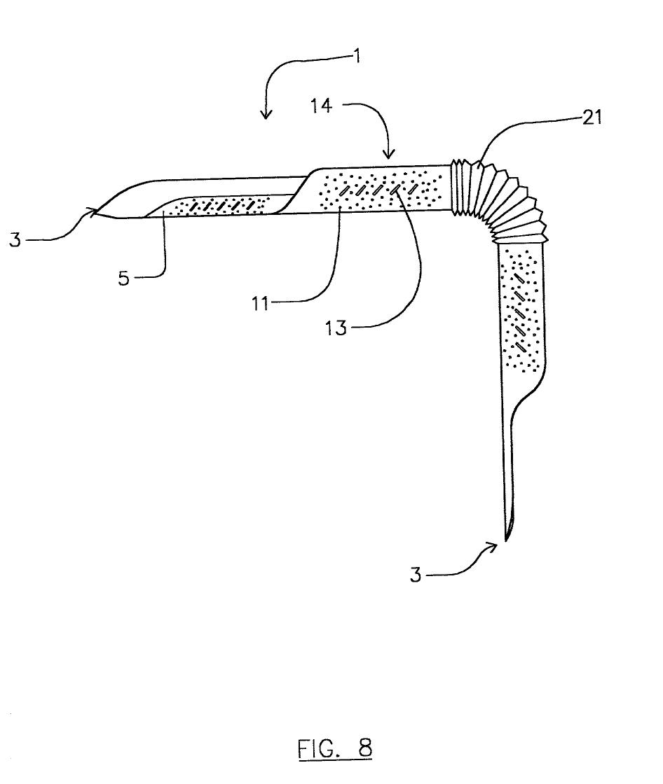

FIG. 8 is a plan view of a fifth embodiment of strip 1 having different configurations at each end thereof. The strip 1 comprises a center section having extendible concentric rings 21. The extendible concentric rings 21 may be twisted or bent such that each tine 3 may assume different angles with respect to the other end of the strip 1. At one end of the tubular type strip 1, the tine 3 is similar to the one shown in FIG. 4. The strip 1 on this end has half the circumference of the tube 14 from the tine 3A where it is slanted backward from the bottom to the top. It is also slanted laterally near the grip 7 to or near such point that is normally one-eighth the length of the strip 1. A fold 5 runs along the bottom length to a point near the full tube and grip 7 that is formed with extendible concentric rings 21 from which the full tube 14 continues. A second tine 3B is shown at the opposite end of the strip 1. The second tine 3B is the type shown in FIG. 2.

As mentioned previously, the extendible concentric rings 21 permit the bending of the tube 14 and the tines 3 at selected angles. They may be returned to a straight or other angle for use or storage. Such arrangement provides the user with a selection of either tine 3 for particular teeth and a means to reach them from different holding positions. The holes 11 and slots 13 may be included along the length of either or both tines 3.

It should be noted that the aforementioned different tines can be arranged in various points and patterns on the strip mentioned in FIG. 8 without deviating from the scope of the present invention.

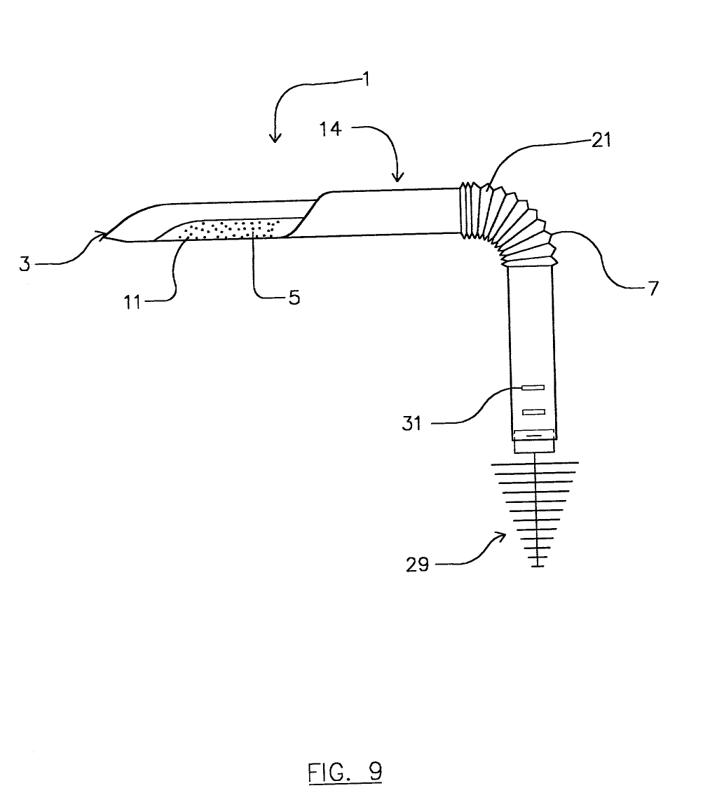

FIG. 9 is a sixth embodiment of the present invention and a plan view of a FIG. 4 type tine 3 at one end of the strip 1. The tine 3 connects to a tube 14 having extendible concentric rings 21. A brush 29 that has fine bristles extends from the opposite end of tube 14. The tube 14 may include threading or notches for holding the brush 29 in place. Or, the brush 29 may be permanently affixed to the tube 14.

In FIG. 9, the strip 1 is halved along its length to a selected point on the tube 14 near the extendible concentric rings 21. The concentric rings 21 comprise the grip 7. Notches or threading means 31 for holding the brush 29 are located at an opposite end of the concentric rings 21. It should be noted that both ends of the extendible concentric rings 21 may be similarly threaded or slotted to provide catches to enable insertion and fastening the ends of selected strips or other dental devices in either end as desired.

It is to be understood that the invention is not limited to the exact construction illustrated and described above. Various changes and modifications may be made without departing from the spirit and the scope of the invention as defined in the following claims.

I claim:

1. A dental hygiene device for removing food debris, deposits or tartar from teeth comprising:
a thin flexible strip of plastic having a bottom, a top, a length and a width;
a tine at one end of said strip of plastic; and
a finger grip at an opposite end of said strip of plastic.

2. The dental hygiene device of claim 1 further comprising:
a fold along the bottom of said thin flexible strip of plastic that adds a groove rigidity to the thin flexible strip of plastic.

3. The dental hygiene device of claim 2 further comprising:
holes at selected points in the plastic strip, fold or both.

4. The dental hygiene device of claim 2 further comprising:
slots in said plastic strip, fold or both.

5. The dental hygiene device of claim 1 further comprising:
mesh laminated to at least one side of the finger grip.

6. The dental hygiene device of claim 1 wherein said thin flexible strip of plastic has a tapered width from the tine to the finger grip of between 0.225 to 0.250 inches.

7. The dental hygiene device of claim 1 further comprising:
holes at selected points in the plastic strip.

8. The dental hygiene device of claim 1 further comprising:
slots in said plastic strip.

9. The dental hygiene device of claim 1 further comprising:
sacs or plugs of absorbent materials.

10. The dental hygiene device of claim 1 wherein said plastic strip includes a tubular shaped portion.

11. The dental hygiene device of claim 10 further comprising:
sacs or plugs of absorbent materials fixed within said tubular shaped portion.

12. The dental hygiene device of claim 10 further comprising:
a fold formed between said tine and said tubular shaped portion.

13. The dental hygiene device of claim 10 further comprising:
mesh laminated around an end of the grip.

14. A dental hygiene device comprising:
a tubular plastic strip having at least one flattened section with a top and a bottom;
a tine cut at one end of the tubular plastic strip, and
a grip formed at an opposite end of the tubular plastic strip.

15. The dental hygiene device of claim 14 wherein said flattened section is shaped with slant from the bottom to the top.

16. The dental hygiene device of claim 14 wherein said tubular plastic strip has a diameter of between 0.125 and 0.200 inches.

17. The dental hygiene device of claim 14 further comprising:
sacs or plugs of absorbent material.

18. A dental hygiene device comprising:
a tubular strip of plastic having a circumference and concentric extendible rings; and,
a first tine having half the circumference of the tubular strip of plastic and cut at one end of the tubular strip of plastic.

19. The dental hygiene device of claim 18 further comprising:
a second tine located at an opposite end of the tubular strip from said first tine.

20. The dental hygiene device of claim 18 further comprising:
means for attaching dental tools at one end thereof.
